(19) United States
(12) Patent Application Publication
(10) Pub. No.: US 2003/0200374 A1
(43) Pub. Date: Oct. 23, 2003

(54) Microcomputer system having upper bus and lower bus and controlling data access in network

(75) Inventors: Shohei Moriwaki, Hyogo (JP); Yoshifumi Azekawa, Hyogo (JP); Osamu Chiba, Hyogo (JP)

Correspondence Address: McDERMOTT, WILL & EMERY, 600 13th Street, N. W., Washington, DC, 20005-3096, US

(73) Assignee: MITSUBISHI DENKI KABUSHIKI KAISHA

(21) Appl. No.: 10/322,532

(22) Filed: Dec. 19, 2002

(30) Foreign Application Priority Data
Apr. 18, 2002 (JP) 2002-116113(P)

(51) Int. Cl. G06F 13/14

(52) U.S. Cl. 710/305

(57) ABSTRACT

An MDIO interface transmits and receives data to and from a host device through an upper serial bus. An MDIO interface transmits and receives data to and from a client device through a lower serial bus. A CPU controls the MDIO interface and the MDIO interface, and controls data transfer between the host device and the client device. It is, therefore, possible that the CPU controls the client device connected to the lower serial bus.

### BACKGROUND OF THE INVENTION

1. Field of the Invention

The present invention relates to a microcomputer system employed in a network such as Ethernet (R), and more particularly to a microcomputer system for controlling data access in the network while dividing a serial bus connecting a host device to a client device into an upper serial bus and a lower serial bus.

2. Description of the Background Art

In recent years, various types of systems for reading and outputting data from a client device in response to a request from a host device have been developed, as exemplified by a system employing an MDIO (Medium Dependent Input/Output) interface used in the Ethernet (R).

FIG. 1 is a block diagram showing one example of conventional network systems corresponding to the Ethernet (R). This network system includes a MAC (Media Access Control) 101 which serves as a host device, and a PMA (Physical Media Attachment) 105, a PCS (Physical Coding Sublayer) 106 and an XGXS (10(X)G eXtension Sublayer) 107 which are connected to MAC 101 through a serial bus 104. Since these devices are well known as those constituting a physical-layer transceiver for the Ethernet (R), they will not be described herein in detail.

FIG. 2 is a view for describing data transfer between MAC 101, and PMA 105, PCS 106 or XGXS 107. MAC 101 is connected to PMA 105, PCS 106 and XGXS 107 (to be also referred collectively to as “client devices” hereinafter) each of which has an MDIO interface mounted thereon, through serial bus 104. A group of these devices are allocated the same port address and the respective client devices are allocated different device addresses.

MAC 101 transmits a port address 202 and a device address 203, thereby selecting a register included in PMA 105, PCS 106 or XGXS 107 to be able to access the desired register.

If MAC 101 reads data from a client device, MAC 101 transmits an instruction code 201 which indicates data read, port address 202 and device address 203 to the client device. The client device refers to port address 202 and determines whether the instruction indicates access to the client device itself. If the instruction indicates access to the client device itself, then the client device refers to device address 203, reads data 205 from the register of the client device corresponding to device address 203, and transmits data 205 to MAC 101. MAC 101 needs to acquire data 205 before turnaround time 204 passes after transmitting device address 203. This turnaround time 204 is normally specified to two cycles. If a clock of 2 MHz is employed, for example, a system should send back data 205 to MAC 101 within 1 μs.

If MAC 101 is to write data to a register of a client device, MAC 101 sequentially transmits instruction code 201 which indicates data write, port address 202, device address 203 and data 205 to the client device, and the client device which corresponds to port address 202 writes data 205 in a register corresponding to device address 203.

As described above, the client device needs to send back data 205 to MAC 101 within turnaround time 204 after MAC 101 transmits device address 203. However, if a microcomputer in the system reads data from the register and transmits the data to MAC 101 after receiving device address 203, the time required to do so exceeds turnaround time 204. Due to this, it is disadvantageously necessary to employ a special hardware to realize this.

Furthermore, since only values 0 to 3 can be allocated as device addresses 203 for the Ethernet (R), respectively, only one device other than PMA 105, PCS 106 and XGXS 107 can be connected to serial bus 104, which signifies a disadvantage of lack of extensibility.

Moreover, to realize a 10-gigabit Ethernet (R), it is necessary to utilize optical communication employing a semiconductor laser or the like. To control this optical communication, a microcomputer which controls peripheral devices such as an A/D (Analog/Digital) converter and a D/A (Digital/Analog) converter is necessary. However, as stated above, the microcomputer is incapable of controlling PMA 105, PCS 106 and XGXS 107, with the result that it is disadvantageously difficult to contain these devices in one device which includes the microcomputer.

### SUMMARY OF THE INVENTION

It is an object of the present invention to provide a microcomputer system which enables a microcomputer to control a client device.

It is another object of the present invention to provide a microcomputer system which can connect an optional number of devices to a serial bus.

It is still another object of the present invention to provide a microcomputer system which can contain a microcomputer and a plurality of client devices in one chip.

According to one aspect of the present invention, a microcomputer system employed in a network for transmitting data corresponding to a request from a host device within predetermined time in response to the request includes: a first interface transmitting and receiving data to and from the host device through an upper bus; a second interface transmitting and receiving data to and from a client device through a lower bus physically different from the upper bus; and a processor controlling the first interface and the second interface, and controlling data transfer between the host device and the client device.

Since the processor controls the first interface and the second interface, thereby controlling data transfer between the host device and the client device, the processor can control the client device connected to the lower bus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one example of conventional network systems corresponding to the Ethernet (R);

FIG. 2 is a view for describing data transfer between MAC 101 and PMA 105, PCS 106 or XGXS 107;

FIG. 3 is a block diagram showing the schematic configuration of a network system which includes a microcomputer system according to a first embodiment of the present invention;

FIG. 4 is a block diagram showing the schematic configuration of a microcomputer system 3 according to the first embodiment of the present invention;

FIG. 5 is a view for describing the operation of an MDIO interface 32; and

FIG. 6 is a block diagram showing the schematic configuration of a network system which includes a microcomputer system according to a second embodiment of the present invention.

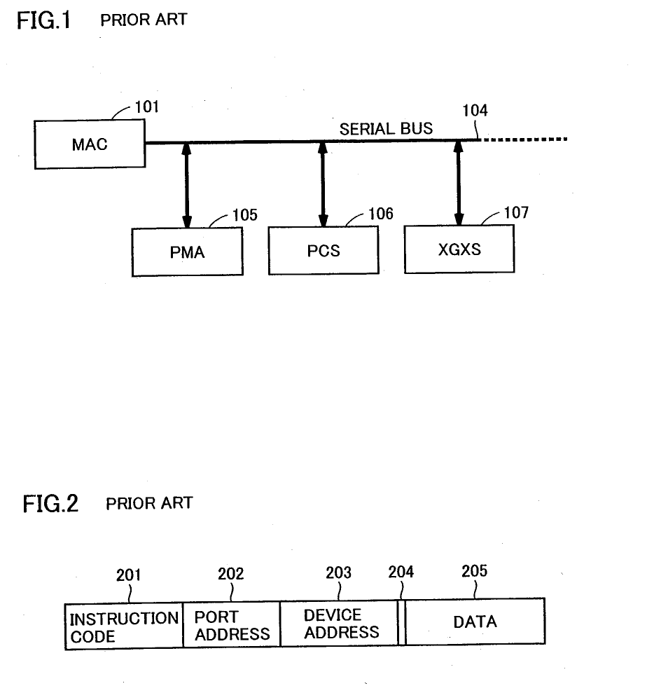

### DESCRIPTION OF THE PREFERRED EMBODIMENTS

(First Embodiment)

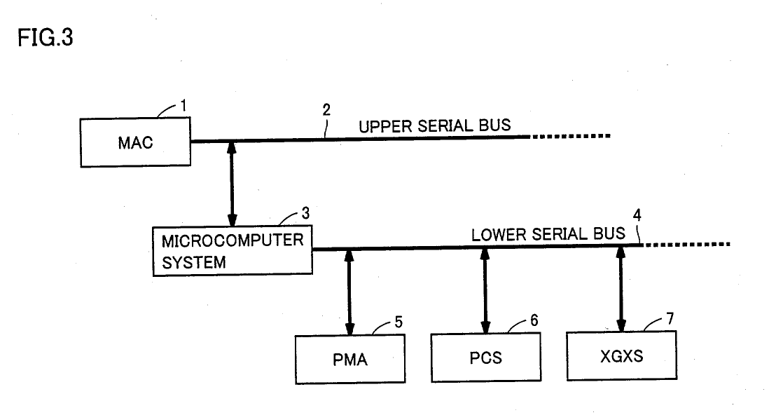

FIG. 3 is a block diagram showing the schematic configuration of a network system which includes a microcomputer system according to the first embodiment of the present invention. This network system includes a MAC 1, a microcomputer system 3 which is connected to MAC 1 through an upper serial bus 2 such as MDIO, and a PMA 5, a PCS 6 and an XGXS 7 which are connected to microcomputer system 3 through a lower serial bus 4.

If microcomputer system 3 receives instruction code 201 which indicates data read, port address 202 and device address 203 from MAC 1 through upper serial bus 2, microcomputer system 3 reads the content of the register of one of PMA 5, PCS 6 and XGXS 7 (which devices will be collectively referred to as “client devices” hereinafter) corresponding to device address 203 from a cache memory (primary storage medium) to be described later at high rate and transmits the content to MAC 1.

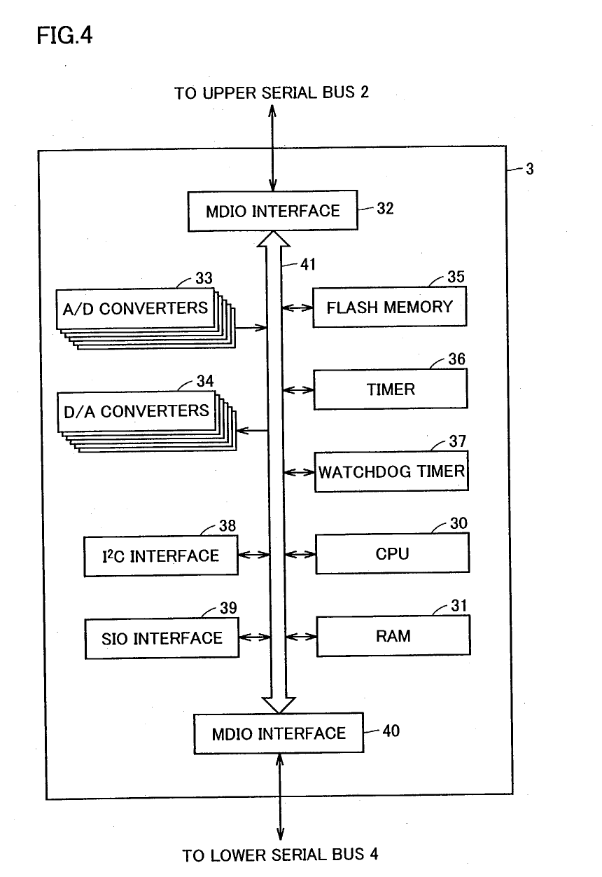

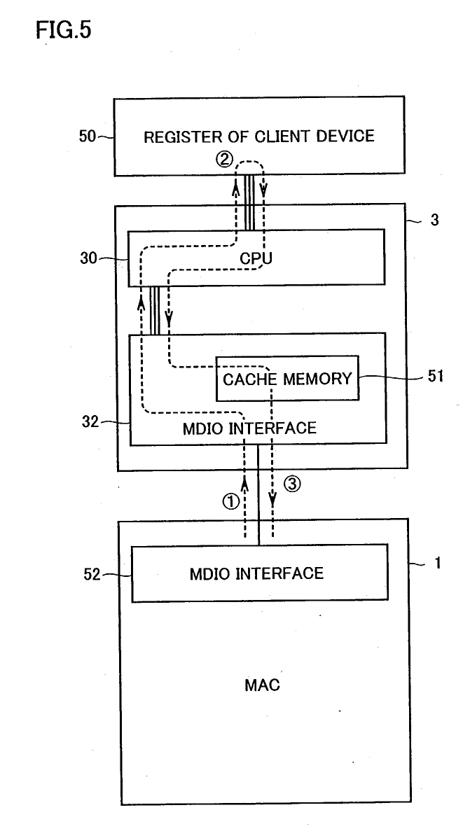

FIG. 4 is a block diagram showing the schematic configuration of microcomputer system 3 according to the first embodiment of the present invention. This microcomputer system 3 includes a CPU (Central Processing Unit) 30 which controls overall microcomputer system 3, a RAM (Random Access Memory) 31 which is employed to store an executed program and employed as a work area or the like, an MDIO interface 32 which is connected to upper serial bus 2, a plurality of A/D converters 33, a plurality of D/A converters 34, a flash memory 35, a timer 36, a watchdog timer 37, an I²C (International Institute for Communication) interface 38, an SIO (Serial Input/Output) interface 39, and an MDIO interface 40 which is connected to lower serial bus 4. Note that these devices included in microcomputer system 3 are connected each other through an internal bus 41, and input/output operation for data, control signals or the like is performed.

When MDIO interface 32 receives instruction code 201 which indicates data read and port address 202 from MAC 1 through upper serial bus 2, CPU 30 reads data from the registers of PMA 5, PCS 6 and XGXS 7 through MDIO interface 40 and stores the data in a cache memory (primary storage medium) which is provided in MDIO interface 32. When MDIO interface 32 receives device address 203 from MAC 1 through upper serial bus 2, CPU 30 reads the data corresponding to the device address from the cache memory and transmits the data to MAC 1 through MDIO interface 32.

FIG. 5 is a view for describing the operation of MDIO interface 32. MDIO interface (serial external interface) 32 includes a cache memory (primary storage medium) 51 which temporarily stores the data read from the registers (secondary storage mediums) 50 of the client devices provided outside of microcomputer system 3 and which has high access rate.

When receiving instruction code 201 which indicates data read from an MDIO interface 52 in MAC 1, MDIO interface 32 receives port address 202 following instruction code 201 and decodes port address 202. As indicated by (1) of FIG. 5, MDIO interface 32 transmits the decoding result to CPU 30. If the decoding result from MDIO interface 32 corresponds to registers 50 of the client devices, CPU 30 reads data at all device addresses corresponding to port address 202 from registers 50 of the client devices and writes the data to cache memory 51 as indicated by (2) of FIG. 5.

When receiving device address 203 following port address 202, MDIO interface 32 decodes device address 203, outputs the decoding result to cache memory 51, and allows cache memory 51 to output data corresponding to device address 203 as indicated by (3) of FIG. 5. MDIO interface 32 converts the data received from cache memory 51 into serial data and transmits the serial data to MDIO interface 52 in MAC 1 through upper serial bus 2.

Further, when receiving instruction code 201 which indicates data write from MDIO interface 52 in MAC 1, MDIO interface 32 receives and decodes port address 202 and device address 203 following instruction code 201 and outputs the decoding result to CPU 30. If the decoding result received from MDIO interface 32 corresponds to register 50 of the client device, CPU 30 receives data 205 from MDIO interface 32 and writes data 205 to register 50 of the client device corresponding to device address 203.

As can be seen, if MAC 1 transmits instruction code 201 and the like to the client device to allow the client device to perform a processing, microcomputer system 3, in replace of MAC 1, controls the client device to perform the processing, and allows CPU 1 to pseudo-access the client device for access to the client device from MAC 1.

FIG. 4 will be described again. If the port address received from MDIO interface 32 corresponds to the registers of the client devices, CPU 30 reads data from the registers of the client devices through MDIO interface 40, and writes the data to cache memory 51 in MDIO interface 32.

MDIO interface 40 differs from MDIO interface 32 in that MDIO interface 40 does not have a function of caching data in the register of the client device but has only a function of transmitting and receiving data to and from the client device through lower serial bus 4 using MDIO. As already described above, since MDIO interface 32 has a function of caching the data of the register of the client device, MDIO interface 40 is not constrained by turnaround time 204. Accordingly, CPU 30 can transmit and receive data to and from the client devices or the other devices connected to lower serial bus 4 at low rate.

Further, as described above, since it is only permitted to allocate values 0 to 3 as device addresses 203, respectively, in the Ethernet (R), MDIO interface 32 is constrained by this prescription; however, MDIO interface 40 is not constrained thereby. That is, CPU 30 can allocate an optional device address to the client device or the other device connected to lower serial bus 4 and access the client device or the other device through MDIO interface 40 using the arbitrary device address.

Consequently, it is possible to allocate device addresses other than device addresses 0 to 3 to the client devices and the other devices, respectively and to connect an optional number of devices to lower serial bus 4. It is noted that these device addresses are stored in flash memory 35 in advance. CPU 30 refers to the device addresses stored in flash memory 35 and accesses the client devices and the other devices connected to lower serial bus 4.

CPU 30 transfers a program which is stored in a nonvolatile memory such as flash memory 35 to RAM 31, and executes the program transferred to RAM 31, thereby controlling overall microcomputer system 3. CPU 30 sets time to timer 36 and watchdog timer 37, receives interrupt requests outputted from timer 36 and watchdog timer 37, and performs a predetermined operation, thereby controlling overall microcomputer system 3.

Further, microcomputer system 3 includes a plurality of A/D converters 33 and a plurality of D/A converters 34 to control a semiconductor laser or the like. CPU 30 controls these A/D converters 33 and D/A converters 34, thereby realizing optical communication employed in the 10-gigabit Ethernet (R). Although microcomputer system 3 includes I²C interface 38 and SIO interface 39 to give extensibility, these elements are not directly relevant to the present invention and not described herein in detail.

As described above, according to microcomputer system 3 in the first embodiment, MDIO interface 32 connected to upper serial bus 2 and MDIO interface 40 connected to lower serial bus 4 are provided, CPU 30 receives an instruction from MAC 1 to a client device and the client device is controlled to execute the instruction. It is, therefore, possible to connect the client device, which has been conventionally connected to MAC 1 through the MDIO serial bus, to lower serial bus 4 as it is.

Furthermore, if a request to read the content of register 50 in the client device is issued from MAC 1, the data stored in cache memory 51 in MDIO interface 32 is transmitted to MAC 1. As a result, the client device is not constrained by turnaround time 204, making it possible for CPU 30 to directly control the client device.

Moreover, CPU 30 can allocate optional device addresses to the client devices and the other devices connected to lower serial bus 4, respectively, and an optical number of devices can be connected to the MDIO serial bus. It is, therefore, possible to add a new function which is not specified according to the Ethernet (R).

Additionally, since CPU 30 controls overall microcomputer system 3, it is possible to include peripheral devices such as A/D converters 33 and D/A converters 34 in the same chip.

(Second Embodiment)

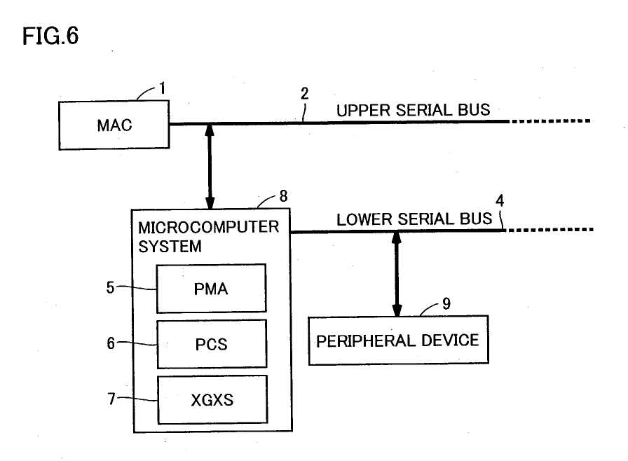

FIG. 6 is a block diagram showing the schematic configuration of a network system which includes a microcomputer system according to the second embodiment of the present invention. This network system includes MAC 1, a microcomputer system 8 which is connected to MAC 1 through upper serial bus 2 such as MDIO, and a peripheral device 9 which is connected to microcomputer system 8 through lower serial bus 4.

Microcomputer system 8 according to the present embodiment differs from microcomputer system in the first embodiment shown in FIG. 3 in that PMA 5, PCS 6 and XGXS 7 which are connected to lower serial bus 4 are included in microcomputer system 8. Therefore, overlapped configuration and functions will not be repeatedly described herein in detail.

PMA 5, PCS 6 and XGXS 7 are connected to an internal bus 41 of microcomputer system 8. This makes it unnecessary to provide these client devices with MDIO interfaces, respectively, and CPU 30 can directly access registers in these client devices.

Further, peripheral device 9 is connected to lower serial bus 4, and CPU 30 can access peripheral device 9 through MDIO interface 40. It is, therefore, possible to connect an arbitrary number of peripheral devices 9 to lower serial bus 4.

As described so far, according to microcomputer system 8 in this embodiment, PMA 5, PCS 6 and XGXS 7 are included in microcomputer system 8. Therefore, in addition to the advantages described in the first embodiment, it is possible to contain microcomputer 30, the client devices, A/D converters 33, D/A converters 34 and the like in one chip, thereby constructing devices having advanced functions.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A microcomputer system employed in a network for transmitting data corresponding to a request from a host device within predetermined time in response to said request, comprising:
a first interface transmitting and receiving data to and from said host device through an upper bus;
a second interface transmitting and receiving data to and from a client device through a lower bus physically different from said upper bus; and
a processor controlling said first interface and said second interface, and controlling data transfer between said host device and said client device.

2. The microcomputer system according to claim 1, wherein
said first interface and said second interface are a Medium Dependent Input/Output interface, respectively.

3. The microcomputer system according to claim 1, wherein
said first interface includes a cache memory,
said processor, when said first interface receives an instruction code and a port address from said host device, reads a content of a register of the client device connected to said lower bus and stores the content in said cache memory, and
said first interface, when receiving a device address from said host device, reads data corresponding to the device address from said cache memory and transmits the data to said host device.

4. The microcomputer system according to claim 1, wherein
said processor, when said first interface receives an instruction code from said host device, instructs execution of said instruction code to said client device through said second interface.

5. The microcomputer system according to claim 1, wherein
said processor allocates an optional device address to a device connected to said lower bus, and transmits and receives data to and from the device connected to said lower bus using the device address.

6. The microcomputer system according to claim 1, wherein
said client device is included in said microcomputer system.
